(19) United States
(12) Patent Application Publication
(10) Pub. No.: US 2005/0268590 A1
(43) Pub. Date: Dec. 8, 2005

(54) Self propelled leaves sweeper machine with internal-combustion engine

(76) Inventor: Marrell Haney, Chicago, IL (US)

Correspondence Address: Marrell Haney, 1301 West 96th Street, Chicago, IL, 60643, US

(21) Appl. No.: 11/144,964

(22) Filed: Jun. 3, 2005

Related U.S. Application Data
(60) Provisional application No. 60/576,134, filed on Jun. 3, 2004.

(51) Int. Cl. A01D 7/00

(52) U.S. Cl. 56/400.01

(57) ABSTRACT

A self propelled leaves sweeper machine adapted for motor driven and having wheels provided with tubeless tires; and set forth in the present invention are rear wheels complimented with axle and front wheels that are adapted for rotating on a front axle The machine operator can easily maneauver the raking apparatus that is partially supported by a fifth wheel that rotates on a vertical axis rod adapted axis. Provided in the invention is a motor driven machine that is powerful enough for raking wet leaves and pushing light snow. Although it is self propelled, it is also adapted for manually operation. Unlike most prior art that have very little control over leaves during high winds, The present invention is adapted with a leaves controlling basket that makes clearing wet and dry leaves from yards quick and easy. Because of the low gas and oil consumptions, a low cost for building the machine, the cost of ownership, it is more affordable.

### BACKGROUND OF THE INVENTION

1. Field of the Invention

This invention relates generally to lawn/yard sweeper machine and more particularly, motor operated leaves sweeper mach-

2. Description of the Related Art

Yard machines of this character are typically adapted for blowing and maneauvering leaves from yards and sidewalks which is possible during mild weather, but, it is very difficult to sucessfully maneauver leaves, especially at times when the wind element is actively blowing; In such cases, it is difficult or literally impossible to control the flow of blowing leaves. However, the self propelled leaves sweeper machine of this character is adapted for manipulating leaves under most conditions.

### SUMMARY OF THE INVENTION

It is an object of the present invention to provide a self propelled power motor driven leaves machine adapted for engines having adequate horsepower to propel wet leaves and dry leaves across lawns and sidewalks and pushing them into a pile and the like.

It is a further object of the present invention is to provide a self propelled leaves sweeper machine having rear wheel drive that is driven by a chassis apparatus which is activated by a series of control devices including an on/off switch, starter, carburetor and choke device. The self propelled leaves sweeper machine is also adapted for moving snow from sidewalks.

It is another object of the present invention to provide a low cost, easy to use leaver sweeper machine adapted to perform most functions that are provided by other yard machines.

The foregoing objects are realized in accordance with the present invention by providing a self propelled leaves sweeper machine adapted for gas and oil inputs having spark plugs ignitions. The self propelled machine is also adapted with a rear axle that causes the rear wheels to turn together, and a front section providing wheels which are adapted for turning on an adjustable horizontal axle, providing control and suspension for the sweeper device and the like while maneauvering leaves.

### BRIEF DESCRIPTION OF THE DRAWINGS

FIG. 1 is a perspective view showing a self propelled leaves sweeper machine having motor powered functions in accordance with the present invention.

FIG. 2 is a perspective view of a leaves sweeper device comprised of aluminum steel and plastic materials. The sweeper unit is adapted for maneauvering on a spring adapted vertical axis.

FIG. 3 is a perspective view showing the primary devices that introduce and control energy which provides for a functionable machine, as further understood in the drawings.

### DETAILED DESCRIPTION OF THE DRAWINGS

Preferred embodiments of the present invention may be best illustrated by referring to the attached figures.

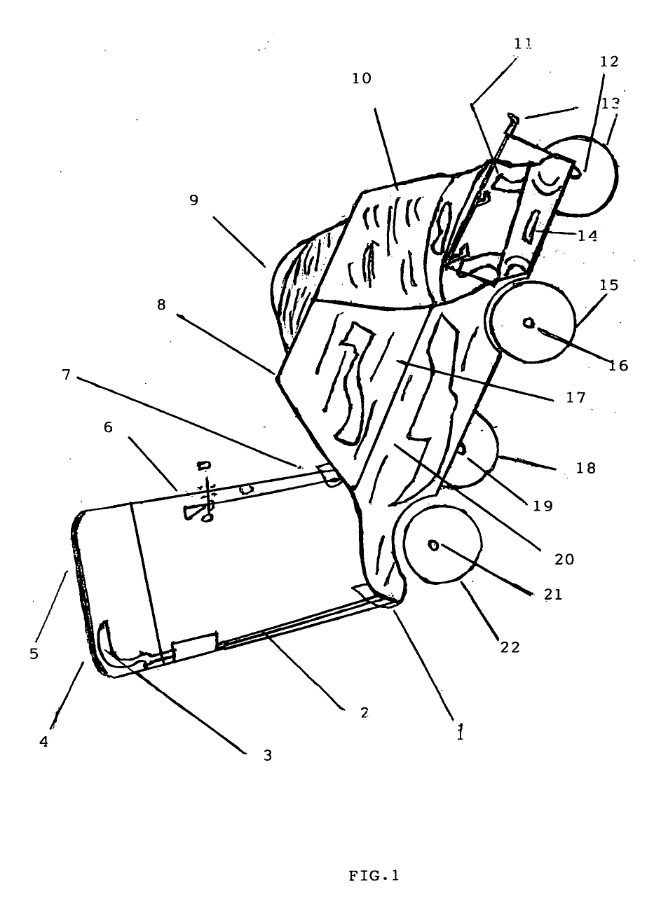

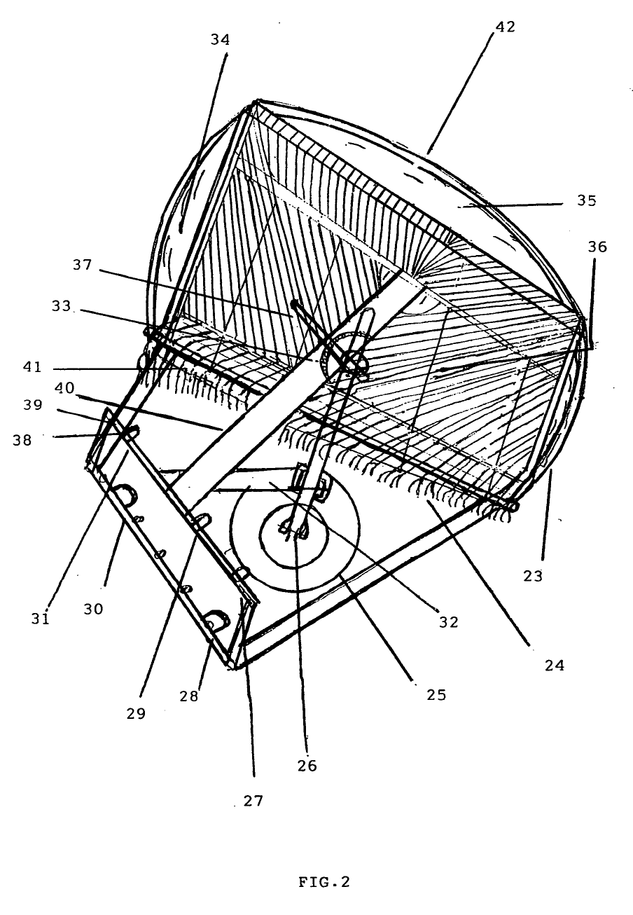

Referring to FIG. 1 is a schematic view of a self propelled leaves sweeper machine's dome unit comprising of gas and oil tanks which are preferably installed underneath the dome panel 9. The dome panel which joined to the top section 8 is preferably fastened to the top side 8 by welding or by the use of metal screws or the like. body frame panel 10 is pivot down at the front grille panel 14 which provides a bracket device 11 for attaching leaves sweeper unit FIG. 2, which is provided with pivot posts that are used for inserting into the front housing of leaves sweeper 30. The machine's right side 17 is provided with upper side panel that connects to lower side panel 20. The process is preferably done by welding or by the use of metal screws in building the machine's body. The front end section 14 is supported by wheels 13 and 15 which are attached to axle 12 and 16 with lug nuts and the like. A rear end section FIG. 1 is comprised of a rear axle having wheels 18 and 22 that joined onto axle with metal nuts, screws and lock washers and the like to the axle's wheel sections 21 and 19 The handle bar 5 is adapted with a starter coil 6 which pivots up from connecters 1 and 7 where the handle snap-into connection sections 1 and 7. An on/off starter control-line 2 comprosing a power control grip-handle 3 is performed through the use of the switch by pulling coil 6 to start the engine and by squeezing the grip-handle and holding it to the handle bar section 4.

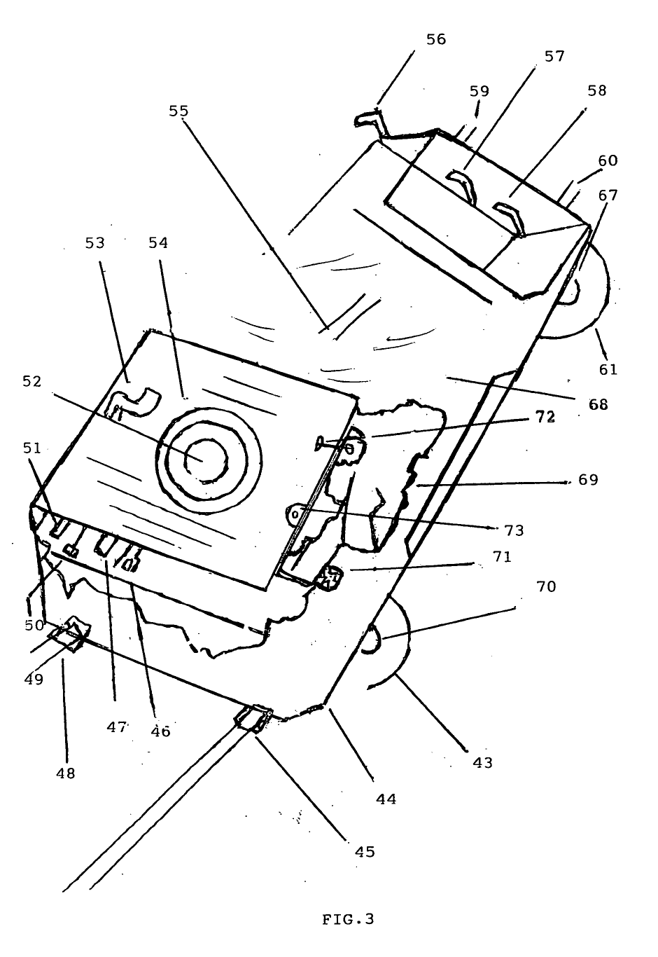

Referring to FIG. 2 is a leaves sweeper unit comprising a metal bracket housing 39 having attachment rings 27,29 and 38 at elevated sections 27,29, and 38 and comprising lower section of the bracket housing which consists of clams devices 28 and 30 which are adapted for connecting onto posts 59 and 60 as shown in FIG. 3.

Referring to FIG. 3 is a perspective view of the frame having a power plant 52 comprising an oil tank 72 at the right side of engine 69 which accordane to the present invention is provided with a self propelled leaves sweeper that is adapted for performing at a quality level while pushing leaves that may be wet and heavy, even while the sweeper's hopper FIG. 2 is filled to capasity in hopper basket 42 as seen in FIG. 2. and also in FIG. 2 are leaves devider, ring blades 23 and 34 that have narrow edges which are adapted for seperating and containing the leaves as they enter basket 42 and, packed into nets 35 and 36. Spindle 33 comprising a cork lever 37 is adapted for adjusting the height of the basket 42 from a special wheel 25 that is attached to vertical axis 32 which pivots down from adjustable spindle 33 to axle wheel connecting area 26.bar 32 which pivots horizontally from housing bracket 30 to vertical axis 26 as a reinforced stabilizer for axis 26. Another stabilizer bar 40 is also a main joining bar having connection at spindle 33 and housing bracket 30. welding together the aluminum steel bar section is desirable. plastic and metal materials are preferably provided for leaves sweeper flex-stems 24 and 41.

Referring to FIG. 3 which is also provided with a front end section comprising support clamps 56,57 and 58 for connecting to leaves sweeper FIG. 2 and are supported with pivot posts 59 and 60 for inserting into sweeper's support rings 28 and 30 as seen in FIG. 2 the front frame FIG. 3 is supported by wheels 61 which have bases of attachment at front end axle unit. And as shown in FIG. 3 are front panel area 55 and 68. the rear section 44 having a power plant comprising motor 69, a gas tank 73 and oil tank 72 provide lubrication and energy for motor 69: it is also complimented with carburetor 71. Several electric devices including on/off switch 51, choke device 50, a power activitor 47 and gear lever 46 which releases and control the power serges through motor 69; it is also provided with exhust device 53; the top side 54 provides a control and release function. Frame 44 adapted for rear handle bar 49 which is also joined to frame sections 45 and 48. The handle bars are fitted onto the rear frames 45 and 48 with bracket devices. And in accordance to the invention, frame 44 is supported on a rear axle 70 which is adapted to turn wheel 43. It should be clearly understood that the self propelled leaves sweeper machine is provided with a front and back side, and a left and right side: they are mirror image of each in shape and designs. The primary functions of the machine are sweeping and pushing wet and dry leaves into piles to be gethered and desposed off.

1. A self propelled leaves sweeper machine having motor driven power comprising;
a Wheels supported leaves sweeper machine comprising an adjustable spindle device having support bracket bar for wheels that are adapted for a vertical axis;
a leaves sweeper provided with housing brackets and inserters rings for locking posts devices designed for front end hook-ups to front section of self propelled leaves sweeper device;
a self propelled leaves sweeper machine designed for pushing wet and dry leaves into piles;
a leaves basket adapted for collecting and controlling leaves flow as the leaves enter the basket.
